(19) United States
(12) Patent Application Publication
(10) Pub. No.: US 2025/0001577 A1
(43) Pub. Date: Jan. 2, 2025

(54) TOOLSET ORGANIZER

(71) Applicant: Bryan Hickey, Ninilchik, AK (US)

(72) Inventor: Bryan Hickey, Ninilchik, AK (US)

(21) Appl. No.: 18/885,549

(22) Filed: Sep. 13, 2024

Related U.S. Application Data
(63) Continuation-in-part of application No. 17/819,148, filed on Aug. 11, 2022, now Pat. No. 12,115,647.

(51) Int. Cl. B25H 3/00

(52) U.S. Cl. CPC B25H 3/00

(57) ABSTRACT

A toolset organizer for organizing box-end wrenches includes a multiple of connectors each comprising a male polygon section connector body adjacent to a flange along an axis, each male polygon section connector body different in size, each of the multiple of connectors at least partially receivable into another of the multiple of connectors along the axis; and a cylindrical section that extends from the male polygon section connector body along the axis of each of the multiple of connectors, the cylindrical section contains a first magnet such that the cylindrical section receivable into an opening through the flange and at least partially into the male polygon section connector body of only one of the multiple of connectors that each respectively contains a magnet to provide a magnetic interface that at least partially retains the multiple of connectors one to another.

### CROSS-REFERENCE TO RELATED APPLICATION(S)

This application claims the priority as a continuation-in-part of U.S. Nonprovisional patent application Ser. No. 17/819,148 (01609-HIC) filed Aug. 11, 2022. Each of the aforementioned patent applications, and any applications related thereto, are herein incorporated by reference in their entirety.

### FIELD

The present application generally relates to a toolset organizer that organizes wrenches.

### BACKGROUND

Toolboxes often contain various tools, however, often become somewhat unorganized. Although wrench trays, racks, or compartment slots facilitate organization of tools, these devices may be bulky and waste space within the toolbox and not allow for varying the quantity of wrenches to be organized/secured.

### SUMMARY

A toolset organizer for organizing box-end wrenches according to one disclosed non-limiting embodiment of the present disclosure includes a multiple of connectors each comprising a male polygon section connector body adjacent to a flange along an axis, each male polygon section connector body different in size, each of the multiple of connectors at least partially receivable into another of the multiple of connectors along the axis; and a cylindrical section that extends from the male polygon section connector body along the axis of each of the multiple of connectors, the cylindrical section contains a first magnet such that the cylindrical section receivable into an opening through the flange and at least partially into the male polygon section connector body of only one of the multiple of connectors that each respectively contains a magnet to provide a magnetic interface that at least partially retains the multiple of connectors one to another.

A further embodiment of any of the foregoing embodiments of the present disclosure includes, wherein each male polygon section connector body comprises a hexagon different in size to receive only a single respective box-end wrench.

A further embodiment of any of the foregoing embodiments of the present disclosure includes, wherein each of the multiple of connectors are independently rotatable about the axis relative to the other of the multiple of connectors.

A further embodiment of any of the foregoing embodiments of the present disclosure includes, wherein ridges on each cylindrical section.

A toolset organizer for organizing box-end wrenches according to one disclosed non-limiting embodiment of the present disclosure includes a multiple of connectors each comprising a male polygon section connector body adjacent to a flange along an axis, each male polygon section connector body different in size, each of the multiple of connectors at least partially receivable into another of the multiple of connectors along the axis.

A further embodiment of any of the foregoing embodiments of the present disclosure includes ridges on each cylindrical section.

A further embodiment of any of the foregoing embodiments of the present disclosure includes, wherein the male polygon section connector body comprises a hexagon.

A further embodiment of any of the foregoing embodiments of the present disclosure includes, wherein each of the multiple of connectors is magnetically retained into another of the multiple of connectors along the axis.

A first connector of a toolset organizer for organizing box-end wrenches according to one disclosed non-limiting embodiment of the present disclosure includes a first male polygon section connector body along an axis, the first male polygon section connector body sized to receive a first box-end wrench; a first flange along the axis adjacent to the first male polygon section connector body, the first flange of diameter greater than that of the first male polygon section connector body; a first cylindrical section that extends from the first male polygon section connector body along the axis; and an opening formed through the first flange and at least partially into the first male polygon section connector body to define a female connector portion opening to receive a second connector which comprises a second male polygon section connector body sized to receive a second box-end wrench of a size different than the first box-end wrench.

A further embodiment of any of the foregoing embodiments of the present disclosure includes, wherein the first cylindrical section comprises cylindrical ridges.

A further embodiment of any of the foregoing embodiments of the present disclosure includes, wherein the first cylindrical section is sized to fit within an opening formed through a second flange and at least partially into the second male polygon section connector body of the second connector along the axis.

A further embodiment of any of the foregoing embodiments of the present disclosure includes, wherein the opening formed through the second flange and at least partially into the second male polygon section connector body of the second connector comprises cylindrical ridges to facilitate retention with the first cylindrical section along the axis.

A further embodiment of any of the foregoing embodiments of the present disclosure includes, wherein the first cylindrical section contains a magnet.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a toolset organizer with a multiple of connectors connected together according to one disclosed non-limiting embodiment.

FIG. 2 is an exploded view of the toolset organizer in which the connectors proportionately increase in size.

FIG. 3A is a perspective view of a connector according to one disclosed non-limiting embodiment.

FIG. 3B is a perspective view of a connector according to another disclosed non-limiting embodiment.

FIG. 4A is a schematic cross-sectional view of the connector of FIG. 3A according to one disclosed non-limiting embodiment.

FIG. 4B is a schematic cross-sectional view of the connector of FIG. 3B according to another disclosed non-limiting embodiment.

FIG. 5 is a perspective view of the toolset organizer illustrating organization of a multiple of box-end wrenches.

### DETAILED DESCRIPTION

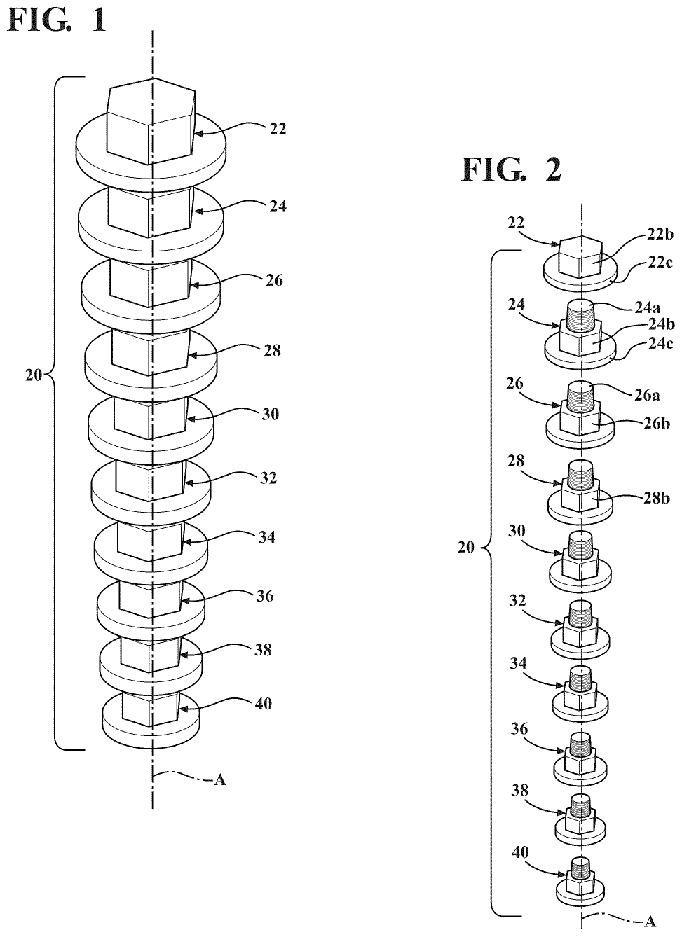

FIG. 1 illustrates an example embodiment of the toolset organizer 20. The toolset organizer 20 includes a multiple of connectors 22, 24, 26, 28, 30, 32, 34, 36, 38, 40, each of which are connectable together. Although a particular number of connectors are illustrated in the disclosed embodiment, it would be appreciated that any number thereof may form the organizer 20. Each connector, is friction fit to essentially “snap” into an adjacent connector to retain a tool such as a box-end wrench between each adjacent pair of connectors 22, 24, 26, 28, 30, 32, 34, 36, 38, 40 with the ability to rotate the tool on a respective connector 22, 24, 26, 28, 30, 32, 34, 36, 38, 40, 42 about an axis A while retaining the other connectors together. Each connector 22, 24, 26, 28, 30, 32, 34, 36, 38, 40 may be progressively sized to accommodate a full set of tools such as a box-end wrench set. The toolset organizer 20 provides ease of wrench accessibility, identification, and transportation, and allows users to rotate desired wrenches individually while maintaining other wrenches in a desired locked or flushed position.

The first connector 24 is exemplary of each of the connectors and generally includes a first male interface 24a, a first male polygon section connector body 24b adjacent to a second flange 24c along axis A. The first male polygon section connector body 24b may be specific to the tool such as a hexagonal wrench. A second female interface 24d is formed through the second flange 24c and at least partially into the first male polygon section connector body 24b to receive and retain a second male interface 26a of a second connector 26 along the axis. The corresponding male and female interfaces may be formed as, for example, a complimentary truncated conical section, a complimentary cylindrical section, or other geometric configuration which provide a mating interface.

Although the first connector 24 is exemplary of each of the connectors, a connector may be a polygon end cap 22 that need not include the male interface portion. The connector polygon end cap 22 may include a first flange 22c along axis A to define a first female interface 22d to receive and retain the first male interface 24a of a first connector 24 along the axis A.

The first male polygon section connector body 24b may be sized to receive a first box-end wrench 50, where the first box-end wrench 50 is placed onto the first male polygon section connector body 24b, so that the first box-end wrench 50 is retained between the first flange 22c and second flange 24c.

The second male interface 26a is sized to fit within the first female interface 22d formed through a second flange 24c and at least partially into the second male polygon section connector body 26b of the second connector 26 along the axis A. The second male polygon section connector body 26b is adjacent to the second flange 24c of the second connector 26 along the axis A, the second male polygon section connector body 26b is sized to receive a second box-end wrench 52, where the second male polygon section connector body 26b is different than the first male polygon section connector body 24b. The third through ninth connectors of the illustrated embodiment follow the same pattern as described above.

With reference to FIG. 2, the connectors are shown separated along the axis A, such that the connectors decrease in size from top to bottom as shown in FIG. 2. The ninth connector 40 in this embodiment is the smallest connector to receive the smallest tool of the toolset. This is followed by the eight connector 38, seventh connector 36, sixth connector 34, fifth connector 32, fourth connector 30, third connector 28, second connector 26, first connector 24, and ending with the polygon end cap 22.

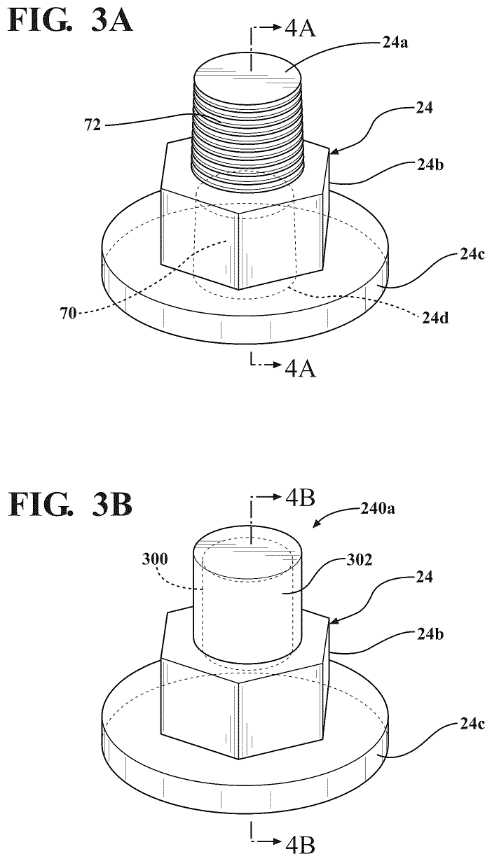

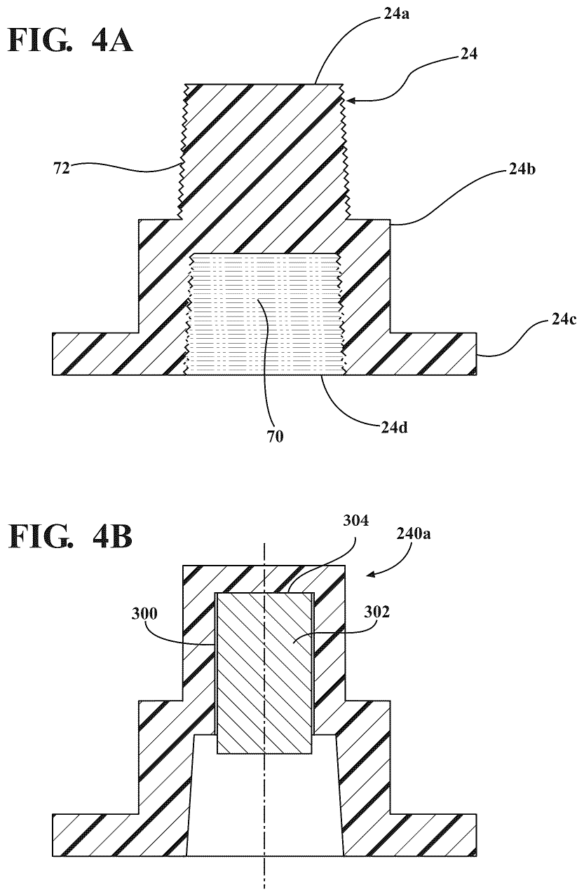

With reference to FIG. 3A, the first male interface 24a that is adjacent to the first male polygon section connector body 24b has first male interface ridges 72 that insert into a first female interface ridges 70 (FIG. 4A) that allow for retention between the connectors. Once the connectors are snapped together, a tool may be retained axially between a pair of connectors on the polygonal section but may also be individually rotated with respect to other tools.

With reference to FIG. 4A, the first male interface ridges 72 from the first male interface 24a for both the first connector 24 and the polygon end cap 22 provide for an interface therebetween. The first male interface 24a of the first connector 24 is inserted into and penetrates the first female interface 22d of the polygon end cap 22. Both the first flange 22c and the second flange 24c serve as reference points to illustrate the depth of how the top of the first male interface 24a and the first male polygon section connector body 24b, of the first connector 24, penetrate into the first female interface 22d of the polygon end cap 22.

With reference to FIGS. 3B and 4B, in another embodiment, the first male interface 240a includes a recess 300 within which a magnet 302 is at least partially received to be adjacent to a top surface 304 that allows for magnetic retention between the connectors. The magnetic retention may be in addition or in the alternative to the first male interface ridges 72 that insert into the first female interface ridges 70 (FIG. 4A). In one example, the magnet 302 may be cylindrical in shape. In this embodiment, the corresponding male and female interfaces may be formed as, for example, a complimentary cylindrical section as the retention therebetween is provided by the magnetic interface.

The female and/or male interfaces may alternatively or additionally include ridges or other friction including features to facilitate retention along the axis A as well rotation about axis A. In one embodiment, the first female interface ridges 70 and first male interface ridges 72 are defined about the axis A. The first male interface ridges 72 interface with the first female interface ridges 70 such that the connectors essentially “snap” together. Once the connectors are snapped together, a tool may be retained axially between each pair of connectors on the respective polygonal section but may also be individually rotated with respect to other tools.

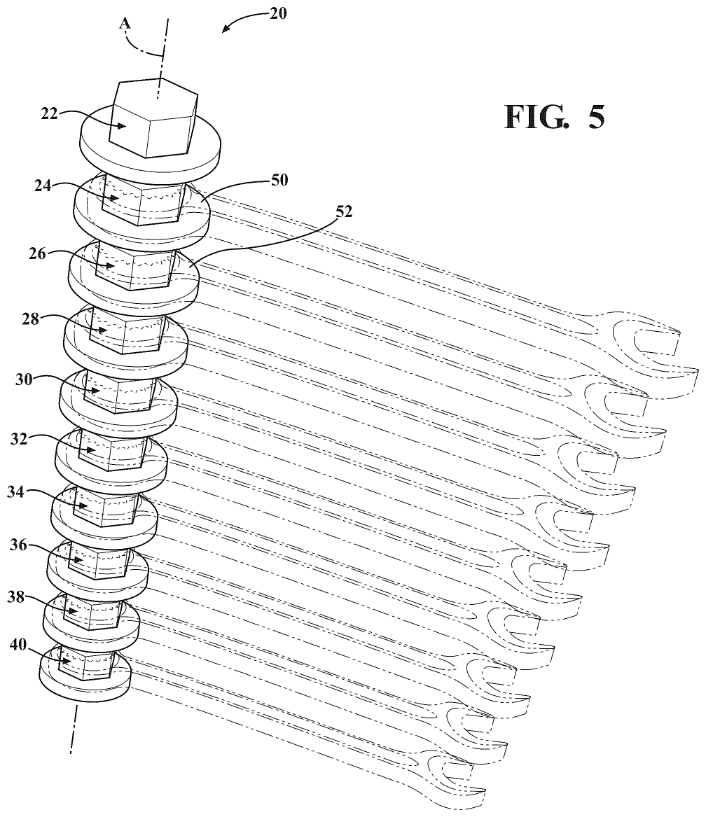

With reference to FIG. 5, the connectors are readily assembled together to form the toolset organizer 20 to organize an example set of box-end wrenches, each of which are of different sizes. The toolset organizer 20 facilitates organizing the box-end wrenches while allowing rotation about axis A to facilitate identification and removal of an induvial wrench. That is, the connectors can also be individually separated to access individual wrenches that may be otherwise difficult to retrieve because the desired wrench is located in the middle of the toolset organization arrangement.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

While various inventive aspects, concepts and features of the general inventive concepts are described and illustrated herein in the context of various exemplary embodiments, these various aspects, concepts, and features may be used in many alternative embodiments, either individually or in various combinations and sub-combinations thereof

Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed.

Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary, or representative values and ranges may be included to assist in understanding the present disclosure; however, such values and ranges are not to be construed in a limiting sense and are intended to be critical values or ranges only if so expressly stated.

Moreover, while various aspects, features and concepts may be expressly identified herein as being inventive or forming part of an invention, such identification is not intended to be exclusive, but there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A toolset organizer for organizing box-end wrenches, the toolset organizer comprising:
a multiple of connectors each comprising a male polygon section connector body adjacent to a flange along an axis, each male polygon section connector body different in size, each of the multiple of connectors at least partially receivable into another of the multiple of connectors along the axis; and
a cylindrical section that extends from the male polygon section connector body along the axis of each of the multiple of connectors, the cylindrical section contains a first magnet such that the cylindrical section receivable into an opening through the flange and at least partially into the male polygon section connector body of only one of the multiple of connectors that each respectively contains a magnet to provide a magnetic interface that at least partially retains the multiple of connectors one to another.

2. The toolset organizer as recited in claim 1, wherein each male polygon section connector body comprises a hexagon different in size to receive only a single respective box-end wrench.

3. The toolset organizer as recited in claim 1, wherein each of the multiple of connectors are independently rotatable about the axis relative to the other of the multiple of connectors.

4. The toolset organizer as recited in claim 1, further comprising ridges on each cylindrical section.

5. A toolset organizer for organizing box-end wrenches, comprising:
a multiple of connectors each comprising a male polygon section connector body adjacent to a flange along an axis, each male polygon section connector body different in size, each of the multiple of connectors at least partially receivable into another of the multiple of connectors along the axis.

6. The toolset organizer as recited in claim 5, further comprising ridges on each cylindrical section.

7. The toolset organizer as recited in claim 5, wherein the male polygon section connector body comprises a hexagon.

8. The toolset organizer as recited in claim 5, wherein each of the multiple of connectors is magnetically retained into another of the multiple of connectors along the axis.

9. A first connector of a toolset organizer for organizing box-end wrenches, comprising:
a first male polygon section connector body along an axis, the first male polygon section connector body sized to receive a first box-end wrench;
a first flange along the axis adjacent to the first male polygon section connector body, the first flange of diameter greater than that of the first male polygon section connector body;
a first cylindrical section that extends from the first male polygon section connector body along the axis; and
an opening formed through the first flange and at least partially into the first male polygon section connector body to define a female connector portion opening to receive a second connector which comprises a second male polygon section connector body sized to receive a second box-end wrench of a size different than the first box-end wrench.

10. The first connector as recited in claim 9, wherein the first cylindrical section comprises cylindrical ridges.

11. The first connector as recited in claim 10, wherein the first cylindrical section is sized to fit within an opening formed through a second flange and at least partially into the second male polygon section connector body of the second connector along the axis.

12. The first connector as recited in claim 11, wherein the opening formed through the second flange and at least partially into the second male polygon section connector body of the second connector comprises cylindrical ridges to facilitate retention with the first cylindrical section along the axis.

13. The first connector as recited in claim 9, wherein the first cylindrical section contains a magnet.
